(19) United States
(12) Patent Application Publication
(10) Pub. No.: US 2025/0074385 A1
(43) Pub. Date: Mar. 6, 2025

(54) DEVICE AND METHOD FOR DETECTING ABNORMALITY OF BRAKE MOTOR, AND NON-TRANSITORY COMPUTER-READABLE STORAGE MEDIUM STORING PROGRAM FOR PERFORMING THE METHOD

(71) Applicant: HL MANDO CORPORATION, Gyeonggi-do (KR)

(72) Inventors: Jongick Won, Gyeonggi-do (KR); Gyuwon Kim, Gyeonggi-do (KR)

(21) Appl. No.: 18/826,110

(22) Filed: Sep. 5, 2024

(30) Foreign Application Priority Data
Sep. 5, 2023 (KR) 10-2023-0117733
May 8, 2024 (KR) 10-2024-0060706

(51) Int. Cl. B60T 17/22; G06N 3/0475; G06N 3/094

(52) U.S. Cl. CPC B60T 17/22; G06N 3/0475; G06N 3/094; B60T 2220/04; B60T 2240/00; B60T 2250/04

(57) ABSTRACT

A brake motor abnormality detection device may detect abnormality of a brake motor generating a driving force to displace a friction member at a side of a wheel of a vehicle to generate a braking force caused by friction due to the displacement of the friction member. The brake motor abnormality detection device includes a memory in which one or more instructions are stored and a processor configured to execute the one or more instructions to input input data to an artificial neural network model configured to receive the input data and output an estimation value of an output variable related to an output of the brake motor, obtain the estimation value of the output variable, and detect whether the brake motor is abnormal by using a difference between the estimation value of the output variable and a measurement value of the output variable.

### CROSS-REFERENCE TO RELATED APPLICATIONS

This application claims priority to and the benefit of Korean Patent Application No. 10-2023-0117733, filed on Sep. 5, 2023, and Korean Patent Application No. 10-2024-0060706, filed on May 8, 2024, the disclosures of which are incorporated herein by reference in their entireties.

### TECHNICAL FIELD

The present disclosure relates to a brake motor abnormality detection device and method and a non-transitory computer-readable storage medium in which a program for performing the method is stored, and more specifically, to a brake motor abnormality detection device and method for detecting the abnormality of a brake motor generating a driving force to displace a friction member disposed at a side of a wheel to generate a braking force caused by friction due to the displacement of the friction member, and a non-transitory computer-readable storage medium in which a program for performing the method is stored.

### RELATED ART

Brake systems for braking are essentially installed in vehicles. Recently, electro mechanical brake (EMB) systems have been proposed to improve braking stability and efficiency.

A general braking function, an anti-lock brake system (ABS), electronic stability control (ESC), vehicle dynamic control (VDC), etc., can be integrally implemented through the EMB system. In addition, the EMB system facilitates implementation of an autonomous driving function of a vehicle.

An EMB system is configured such that a friction member, which is disposed at a side of each wheel of a vehicle and generates a braking force caused by friction upon detecting displacement, is displaced by a driving force provided by a brake motor. In this case, the friction member may be a brake pad capable of pressing a disk that rotates with the wheel of the vehicle. In addition, the brake motor may be disposed at each wheel of the vehicle. Meanwhile, the brake motor may be driven by an electric signal generated according to an input of the brake pedal.

In the EMB system, when the brake motor fails, a braking force corresponding to an input depth of the brake pedal cannot be generated. Accordingly, a severe problem for safety can occur in the vehicle.

In general, an output torque of a brake motor can be reduced due to demagnetization due to degradation, insulation material corrosion, etc. Such output torque reduction of the brake motor gradually occurs. Therefore, it is preferable that the abnormality of the brake motor be prognosed to improve the stability of a brake system. However, the conventional approach related to the abnormality detection of the brake motor is limited to measures for post-diagnosis and follow-up for failure.

### SUMMARY

The present disclosure is directed to solving the above-described problems and providing a brake motor abnormality detection device and method for detecting performance degradation of a brake motor generating a driving force to displace a friction member disposed at a side of a wheel of a vehicle to generate a braking force caused by friction due to the displacement of the friction member before the brake motor fails, and a non-transitory computer-readable storage medium in which a program for performing the method is stored.

The present disclosure is also directed to providing a brake motor abnormality detection device and method for efficiently prognosing output degradation of a brake motor using controller area network (CAN) signals in a vehicle and a non-transitory computer-readable storage medium in which a program for performing the method is stored.

The objects of the present disclosure are not limited to the above-described objects, and other objects that are not mentioned will be able to be clearly understood by those skilled in the art to which the present disclosure pertains from the following description.

In accordance with one aspect of the present disclosure, there is provided a brake motor abnormality detection device for detecting abnormality of a brake motor generating a driving force to displace a friction member disposed at a side of a wheel of a vehicle to generate a braking force caused by friction due to the displacement of the friction member, the brake motor abnormality detection device including a memory in which one or more instructions are stored and a processor configured to execute the one or more instructions, wherein the processor executes the one or more instructions to input input data to an artificial neural network model configured to receive the input data and output an estimation value of an output variable related to an output of the brake motor, obtain the estimation value of the output variable, and detect whether the brake motor is abnormal by using a difference between the estimation value of the output variable and a measurement value of the output variable.

In the brake motor abnormality detection device according to one aspect of the present disclosure, the input data may include one or more of a speed of the vehicle, a lateral acceleration of the vehicle, an input displacement of a brake pedal, and a wheel speed of the vehicle.

In the brake motor abnormality detection device according to one aspect of the present disclosure, the output variable may include a brake clamping force generated by the friction member.

In the brake motor abnormality detection device according to one aspect of the present disclosure, the input data may be obtained through a controller area network (CAN) of the vehicle.

In the brake motor abnormality detection device according to one aspect of the present disclosure, the artificial neural network model may be formed in a generative adversarial network (GAN) including a generator configured to receive the input data and generate the estimation value of the output variable and a discriminator configured to receive the input data and the measurement value of the output variable and output a measurement related discrimination value.

In the brake motor abnormality detection device according to one aspect of the present disclosure, the discriminator further may receive the input data and the estimation value of the output variable and output an estimation related discrimination value.

In the brake motor abnormality detection device according to one aspect of the present disclosure, the artificial neural network model may be built by alternately performing learning of the generator and the discriminator, and the input data and the measurement value of the output variable used for the learning may be obtained in a normal state of each of the vehicle and the brake motor.

In the brake motor abnormality detection device according to one aspect of the present disclosure, the generator may be provided as a multivariate transformer.

In the brake motor abnormality detection device according to one aspect of the present disclosure, the processor may execute the one or more instructions to input error data related to the difference between the estimation value of the output variable and the measurement value of the output variable to an abnormality detection model and determine whether the brake motor is abnormal.

In the brake motor abnormality detection device according to one aspect of the present disclosure, the abnormality detection model may use a one-class support vector machine (OCSVM) algorithm.

In the brake motor abnormality detection device according to one aspect of the present disclosure, there may be a plurality of data sets each including the input data, the measurement value of the output variable, and the estimation value of the output variable, and the error data may include an average and a standard deviation of errors between the measurement values of the output variables and the estimation values of the output variables obtained from the plurality of data sets, a maximum absolute error between the measurement values of the output variables and the estimation values of the output variables obtained from the plurality of data sets, and discrimination values of the discriminator for the input data and the measurement values of the output variables included in the plurality of data sets.

In accordance with another aspect of the present disclosure, there is provided a brake motor abnormality detection method for detecting abnormality of a brake motor generating a driving force to displace a friction member disposed at a side of a wheel of a vehicle to generate a braking force caused by friction due to the displacement of the friction member, the brake motor abnormality detection method including executing, by a processor, one or more instructions to input input data to an artificial neural network model configured to receive the input data and output the estimation value of the output variable related to an output of the brake motor, and obtaining an estimation value of an output variable and detecting, by the processor, whether the brake motor is abnormal by using a difference between the estimation value of the output variable and a measurement value of the output variable.

In the brake motor abnormality detection method according to one aspect of the present disclosure, the input data may include one or more of a speed of the vehicle, a lateral acceleration of the vehicle, an input displacement of a brake pedal, and a wheel speed of the vehicle.

In the brake motor abnormality detection method according to one aspect of the present disclosure, the output variable may include a brake clamping force generated by friction member.

In the brake motor abnormality detection method according to one aspect of the present disclosure, the artificial neural network model may be formed in a generative adversarial network (GAN) including a generator configured to receive the input data and generate the estimation value of the output variable and a discriminator configured to receive the input data and the measurement value of the output variable and output a measurement related discrimination value.

In the brake motor abnormality detection method according to one aspect of the present disclosure, the artificial neural network model may be built by alternately performing learning of the generator and the discriminator, and data used for the learning may be obtained in a normal state of each of the vehicle and the brake motor.

In the brake motor abnormality detection method according to one aspect of the present disclosure, the detecting of whether the brake motor is abnormal may include inputting, by the processor, the input data and the measurement value of the output variable to the discriminator and obtaining the measurement related discrimination value generated by the discriminator and inputting, by the processor, the measurement related discrimination value and error data including values related to the difference between the estimation value of the output variable and the measurement value of the output variable to an abnormality detection model and obtaining an output of the abnormality detection model.

In the brake motor abnormality detection method according to one aspect of the present disclosure, the abnormality detection model may use a one-class support vector machine (OCSVM) algorithm.

In the brake motor abnormality detection method according to one aspect of the present disclosure, there may be a plurality of data sets each including the input data, the measurement value of the output variable, and the estimation value of the output variable, and the error data may include an average and a standard deviation of errors between the measurement values of the output variables and the estimation values of the output variables obtained from the plurality of data sets, a maximum absolute error between the measurement values of the output variables and the estimation values of the output variables obtained from the plurality of data sets, and discrimination values of the discriminator for the input data and the measurement values of the output variables included in the plurality of data sets.

In accordance with still another aspect of the present disclosure, there is provided a non-transitory computer-readable storage medium in which a program including at least one instruction for performing the brake motor abnormality detection method is stored.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view illustrating a configuration of an electro mechanical brake system of a vehicle;

FIG. 2 is a view illustrating a configuration of a brake device disposed at each wheel in the electro mechanical brake system;

FIG. 3 is a view illustrating a configuration of a brake motor abnormality detection device according to one embodiment of the present disclosure;

FIG. 4 is a view illustrating models used for obtaining an estimation value or detecting abnormality in the brake motor abnormality detection device according to one embodiment of the present disclosure;

FIG. 5 is a view illustrating a detailed configuration of an artificial neural network model;

FIG. 6 is a view illustrating a detailed configuration of a generator of the artificial neural network model;

FIG. 7 is a view illustrating operation of the brake motor abnormality detection device according to one embodiment of the present disclosure;

FIG. 8 is a flowchart illustrating a brake motor abnormality detection method according to one embodiment of the present disclosure; and

FIG. 9 is a detailed flowchart illustrating detecting whether the brake motor is abnormal in the brake motor abnormality detection method according to one embodiment of the present disclosure.

### DETAILED DESCRIPTION OF EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

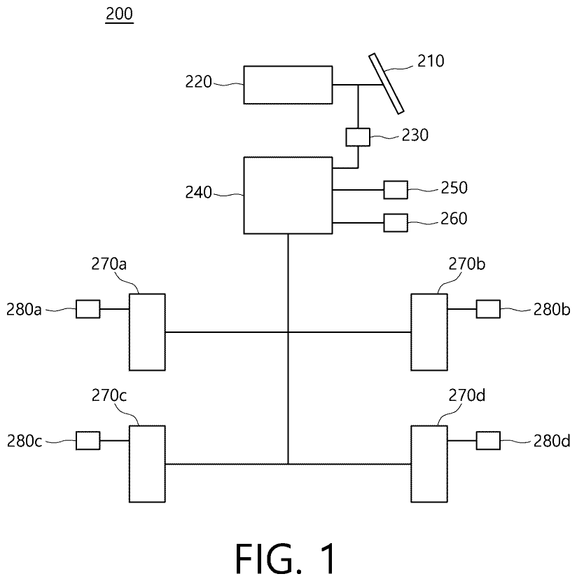

FIG. 1 is a schematic view illustrating a configuration of an electro mechanical brake system of a vehicle.

An electro mechanical brake system 200, that is an electro mechanical brake (EMB) system, is disposed in the vehicle and performs braking of the vehicle. Unlike the conventional hydraulic pressure disk brake, the electro mechanical brake system 200 performs braking using an actuator driven by a brake motor and a mechanical operation principle.

A braking response speed of the electro mechanical brake system 200 may be higher than that of the conventional hydraulic pressure brake, and the electro mechanical brake system 200 may independently and precisely control each wheel. Accordingly, the electro mechanical brake system 200 improves brake safety performance.

Referring to FIG. 1, the electro mechanical brake system 200 may include a brake pedal 210, a pedal simulator 220, a pedal displacement sensor 230, an electronic control unit 240, a vehicle speed sensor 250, an acceleration sensor 260, a first brake device 270a disposed on a front left wheel, a second brake device 270b disposed on a front right wheel, a third brake device 270c disposed on a rear left wheel, a fourth brake device 270d disposed on a rear right wheel, a first wheel speed sensor 280a disposed on the front left wheel, a second wheel speed sensor 280b disposed on the front right wheel, a third wheel speed sensor 280c disposed on the rear left wheel, and the fourth wheel speed sensor 280d disposed on the rear right wheel.

When a pressing force of a driver is input to the brake pedal 210, the brake pedal 210 is displaced toward one side (for example, in a forward direction of the vehicle). The pedal simulator 220 provides a repulsive force to the brake pedal 210. Accordingly, a driver may feel a proper pedaling sensation.

The pedal displacement sensor 230 detects an input depth of the brake pedal 210, which is an input displacement of the brake pedal 210. The input displacement of the brake pedal detected by the pedal displacement sensor 230 may be transmitted to the electronic control unit 240.

The electronic control unit 240 generates a control signal to be transmitted to the first brake device 270a, the second brake device 270b, the third brake device 270c, or the fourth brake device 270d on the basis of the input displacement of the brake pedal detected by the pedal displacement sensor 230.

In this case, the speed of the vehicle detected by the vehicle speed sensor 250 and the lateral acceleration of the vehicle detected by the acceleration sensor 260 may be transmitted to the electronic control unit 240. The electronic control unit 240 may use the input displacement of the brake pedal, the speed of the vehicle, and the lateral acceleration of the vehicle when generating the control signal.

The first brake device 270a, the second brake device 270b, the third brake device 270c, and the fourth brake device 270d may perform braking of the wheels on which respective brake devices are disposed according to the control signal. The first to fourth brake devices 270a, 270b, 270c, and 270d may operate independently.

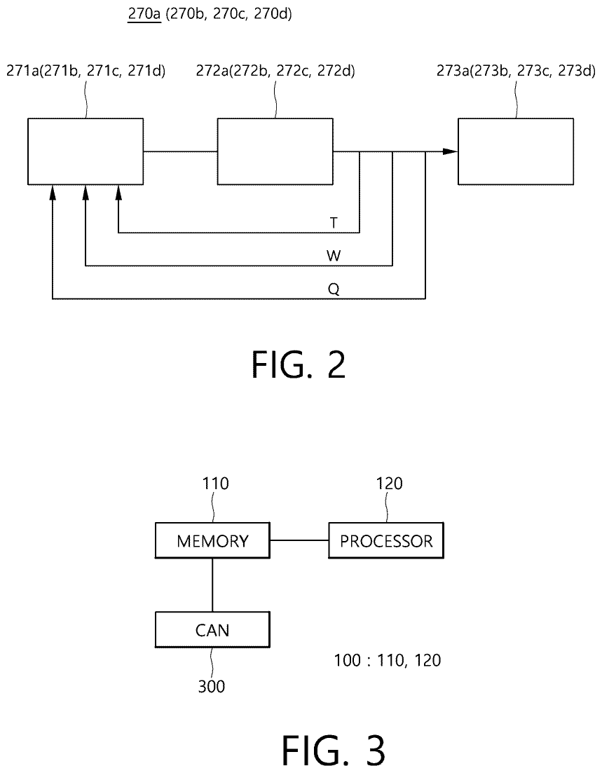

FIG. 2 is a view illustrating a configuration of a brake device disposed at each wheel in the electro mechanical brake system.

Referring to FIG. 2, the first brake device 270a may include a first controller 271a, a first brake motor 272a, and a first friction member 273a. The first controller 271a controls the first brake motor 272a to generate a braking force required according to the control signal. The first brake motor 272a is driven by the first controller 271a and provides a driving force for displacement to the first friction member 273a. The first friction member 273a may be displaced by the driving force provided by the first brake motor 272a to generate the braking force caused by friction. For example, the first friction member 273a may be a brake pad capable of pressing a disk which is disposed on the front left wheel of the vehicle and rotated with the wheel.

A motor torque T, position information w of the motor, and an angular speed θ of the motor according to driving of the first brake motor 272a may be fed back to the first controller 271a. The first controller 271a may receive the motor torque T, the position information w of the motor, and the angular speed θ of the motor and calculate a frictional force and a brake clamping force generated according to displacement of the first friction member 273a.

The second brake device 270b may include a second controller 271b, a second brake motor 272b, and a second friction member 273b. In addition, the third brake device 270c may include a third controller 271c, a third brake motor 272c, and a third friction member 273c. In addition, the fourth brake device 270d may include a fourth controller 271d, a fourth brake motor 272d, and a fourth friction member 273d.

Operation of the second to fourth controllers 271b, 271c, and 271d, operation of the second to fourth brake motors 272b, 272c, and 272d, and operation of the second to fourth friction members 273b, 273c, and 273d may be performed in the same manner of those of the first controller 271a, the first brake motor 272a, and the first friction member 273a described above.

Meanwhile, the first wheel speed sensor 280a detects a wheel speed of the front left wheel, and the second wheel speed sensor 280b detects a wheel speed of the front right wheel. In addition, the third wheel speed sensor 280c detects a wheel speed of the rear left wheel, and the fourth wheel speed sensor 280d detects a wheel speed of the rear right wheel.

The wheel speed detected by each of the first to fourth wheel speed sensors 280a, 280b, 280c, and 280d may be fed back to the electronic control unit 240. The electronic control unit 240 may use the wheel speed of the vehicle with the input displacement of the brake pedal, the speed of the vehicle, and the lateral acceleration of the vehicle to generating the control signal.

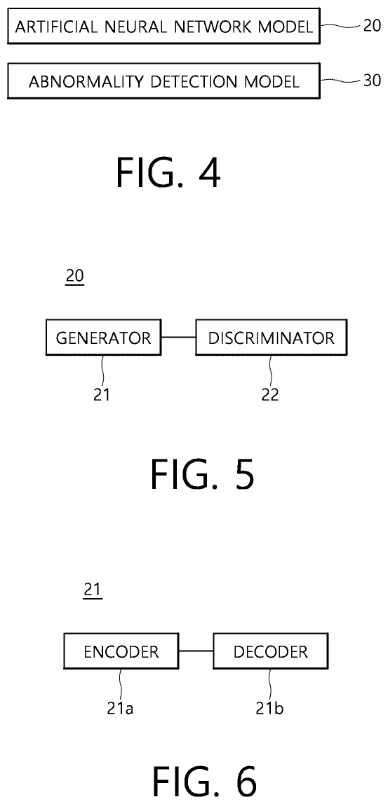

FIG. 3 is a view illustrating a configuration of a brake motor abnormality detection device according to one embodiment of the present disclosure. FIG. 4 is a view illustrating models used for obtaining an estimation value or detecting abnormality in the brake motor abnormality detection device according to one embodiment of the present disclosure.

A brake motor abnormality detection device 100 according to one embodiment of the present disclosure detects abnormality of a brake motor generating a driving force to displace a friction member disposed at a side of the wheel of the vehicle to generate a braking force caused by friction due to the displacement of the friction member. More specifically, the brake motor abnormality detection device 100 may detect output degradation of the brake motor before the brake motor fails.

In this case, the brake motor may include all the first to fourth brake motors 272a, 272b, 272c, and 272d included in the electro mechanical brake system 200.

The brake motor abnormality detection device 100 according to one embodiment of the present disclosure may prognose functional degradation of the brake motor before the brake motor fails through a digital twin algorithm based on an artificial intelligence. The digital twin algorithm may virtually build the electro mechanical brake system of the vehicle.

Referring to FIG. 3, the brake motor abnormality detection device 100 according to one embodiment of the present disclosure may include a memory 110 and a processor 120.

The memory 110 stores one or more instructions. The one or more instructions may be executed by the processor 120.

The memory 110 may include a hardware device configured to store and execute a program instruction. For example, the memory 110 may include storage media such as a read only memory (ROM), a random-access memory (RAM), and a flash memory. In addition, the memory 110 may also include magnetic media such as a floppy disk and a magnetic tape, optical media such as a compact disk read only memory (CD-ROM) and a digital video disk (DVD), magneto-optical media such as a floptical disk, etc.

The processor 120 executes the one or more instructions. For example, the processor 120 may be a hardware unit which performs operation and control in a computer. The processor 120 may include at least one arithmetic logic unit (ALU) and a register.

The processor 120 executes the one or more instructions to input input data to an artificial neural network model 20, which receives the input data and outputs an estimation value of an output variable related to an output of the brake motor, and obtain the estimation value of the output variable.

The input data may include one or more of a speed of the vehicle, a lateral acceleration of the vehicle, an input displacement of the brake pedal, and a wheel speed of the vehicle. For example, the input data may include the speed of the vehicle, the lateral acceleration of the vehicle, the input displacement of the brake pedal, and the wheel speed of the vehicle.

In this case, the wheel speed of the vehicle may be obtained for each of the plurality of wheels of the vehicle. In other words, the wheel speed of the vehicle may include a wheel speed of the front left wheel, a wheel speed of the front right wheel, a wheel speed of the rear left wheel, and a wheel speed of the rear right wheel detected by the first to fourth wheel speed sensors 280a, 280b, 280c, and 280d.

The input data may be obtained through a controller area network (CAN) 300 of the vehicle. For example, the input data may be transmitted to the memory 110 through the CAN 300.

As described above, the input data may be obtained through the CAN 300 of the vehicle. Accordingly, in the case of the present disclosure, an additional sensor related to abnormality detection of the brake motor does not need to be used.

In this regard, the memory 110 may be directly or indirectly connected to the CAN 300 of the vehicle. The memory 110 may receive the input data through the CAN 300. Accordingly, the processor 120 may obtain the input data through the memory 110.

The output variable may include a brake clamping force generated according to displacement of the friction member. In one embodiment of the present disclosure, the brake clamping force may be the output variable.

The brake clamping force may be obtained for each of the plurality of wheels of the vehicle. In other words, the brake clamping force may include a brake clamping force of the first brake device 270a generated by the first friction member 273a, a brake clamping force of the second brake device 270b generated by the second friction member 273b, a brake clamping force of the third brake device 270c generated by the third friction member 273c, and a brake clamping force of the fourth brake device 270d generated by the fourth friction member 273d.

The artificial neural network model 20 receives the input data and outputs the estimation value of the output variable related to the output of the brake motor. More specifically, the artificial neural network model 20 may receive the input data and output an estimation value of the brake clamping force generated according to the displacement of the friction member.

The estimation value of the brake clamping force may include an estimation value of the brake clamping force of the first brake device 270a generated by the first friction member 273a, an estimation value of the brake clamping force of the second brake device 270b generated by the second friction member 273b, an estimation value of the brake clamping force of the third brake device 270c generated by the third friction member 273c, and an estimation value of the brake clamping force of the fourth brake device 270d generated by the fourth friction member 273d.

The estimation value of the output variable is obtained to be compared with a measurement value of the output variable. As described above, the brake clamping force may be the output variable, and the measurement value of the output variable may include a measurement value of the brake clamping force of the first brake device 270a generated by the first friction member 273a, a measurement value of the brake clamping force of the second brake device 270b generated by the second friction member 273b, a measurement value of the brake clamping force of the third brake device 270c generated by the third friction member 273c, and a measurement value of the brake clamping force of the fourth brake device 270d generated by the fourth friction member 273d.

In this case, a controller of the brake device disposed in each wheel of the vehicle may receive operation information of the brake motor and calculate the measurement value of the brake clamping force. For example, the operation information of the brake motor may be the motor torque T, the position information w of the motor, and the angular speed θ of the motor.

In one embodiment of the present disclosure, the artificial neural network model 20 may be formed in a generative adversarial network (GAN).

In one embodiment of the present disclosure, the artificial neural network model 20 may be a neural network model based on deep learning for the electro mechanical brake system 200 of the vehicle. In other words, the artificial neural network model 20 may serve as a virtual twin model of the electro mechanical brake system.

FIG. 5 is a view illustrating a detailed configuration of an artificial neural network model.

Referring to FIG. 5, the artificial neural network model 20 may include a generator 21 and a discriminator 22.

The artificial neural network model 20 may be built by alternately performing learning of the generator 21 and the discriminator 22. In this case, data used for the learning may be obtained in a normal state of each of the vehicle and the electro mechanical brake system. Accordingly, an estimation value of the output variable may follow a measurement value of the output variable in the normal state of each of the vehicle and the electro mechanical brake system.

The generator 21 receives the input data and generates an estimation value of the output variable. The generator 21 may include a neural network. The generator 21 may be provided as a multivariate transformer. That is, the artificial neural network model 20 may be the GAN based on the multivariate transformer.

In one embodiment of the present disclosure, the generator 21 may receive the input data. As described above, the input data may include one or more of a speed of the vehicle, a lateral acceleration of the vehicle, an input displacement of the brake pedal, and a wheel speed of the vehicle.

The generator 21 may operate the input data and output an estimation value of the output variable. In this case, a brake clamping force generated by the friction member may be the output variable. In one embodiment of the present disclosure, an estimation value of the output variable estimated by the generator 21 follows a measurement value of the output variable when the electro mechanical brake system of the vehicle is in a normal state.

FIG. 6 is a view illustrating a detailed configuration of the generator of the artificial neural network model.

Referring to FIG. 6, the generator 21 may include an encoder 21a and a decoder 21b.

The encoder 21a and the decoder 21b are formed in a network for obtaining an estimation value of the output variable. In other words, the generator 21 may be formed in a network with an encoder 21a-decoder 21b structure trained in an end-to-end method to obtain the estimation value of the output variable.

The encoder 21a may be designed to extract high-level features from the input data using a transformer block and a linear operation. In this case, the transformer block may include an embedding layer, a self-attention layer, and a feed-forward layer.

First, in the transformer block, the embedding layer may encode spatiotemporal information into input sequences using a trainable embedding matrix.

Next, deep features may be extracted through the self-attention layer, and refinement may be performed using the feed-forward layer.

In this case, the self-attention layer may use a scaled dot-product attention mechanism. The self-attention layer may be an important component in a deep neural network (DNN) architecture based on a transformer which allows a model to process and understand dependence in an input sequence.

The scaled dot-product attention may apply layer normalization to the input sequence first, and processes a result thereof as three unique vectors of a quarry Q, a key K, and a value V through the linear operation.

Next, an attention score AS for each position of the input sequence may be calculated on the basis of induced vectors. A calculation equation of the attention score AS may be given as Equation 1 below.

$$AS = σ ( \frac{Q \cdot K}{\sqrt{{‖ {x}_{input} ‖}_{dim}}} ) \cdot V \qquad [ Equation 1 ]$$

(σ(·) means a softmax operation, ∥xᵢₙₚᵤₜ∥_{dim} means an input feature dimension, and (·) means dot-product.)

The attention score quantifies relative importance of each position in the input sequence related to a given quarry. That is, a higher score is assigned to a more appropriate position.

An output of the transformer block may be provided to two different linear operations in order to calculate a quarry, a key vector, and an initial input value ŷ₁ of the decoder 21b.

The decoder 21b may use obtained values to estimate one or more estimation values in an automatic regression method similar to sequence-to-sequence recurrent neural networks.

Like the encoder 21a, the decoder 21b may include a transformer block and a linear operation. The decoder 21b may also further includes a cross-attention layer in the transformer block.

The cross-attention layer may perform a scaled dot-product attention using the quarry and the key vector of the encoder 21a in order to training a dynamic correlation between an input signal and an estimation signal.

The discriminator 22 receives the input data and a measurement value of the output variable and outputs a discrimination value. The discrimination value output by the discriminator 22 for the input data and the measurement value of the output variable may be defined as a measurement related discrimination value.

The discriminator 22 is a classifier that aims to determine the conditional probability. The discriminator 22 determines the probability of an example being real or fake given that set of input features. The discrimination value from the discriminator 22 is a classification label. For example, the discrimination value from the discriminator 22 is 0 or 1.

Meanwhile, the discriminator 22 may further receive the input data and an estimation value of the output variable and output a discrimination value. The discrimination value output by the discriminator 22 for the input data and the estimation value of the output variable may be defined as an estimation related discrimination value. This process may be performed while the generator 21 and the discriminator 22 are trained.

As described above, the discriminator 22 outputs the discrimination value for the input data and the measurement value of the output variable in an operation process for detecting abnormality. Meanwhile, in an operation process for training, the discriminator 22 may output a discrimination value for the input data and an estimation value of the output variable.

The discriminator 22 may be formed in a discrimination network used for adversary training the GAN. In other words, the generator 21 and the discriminator 22 may be trained in an adversary training method to improve estimation performance and set a GAN model.

More specifically, optimization of the discriminator 22 and the generator 21 may be alternately performed in order to solve a Wasserstein min-max problem as in Equation 2.

$${min}_{G} {max}_{D} {E}_{{x}_{D , Real}} [ D ( {x}_{D , Real} ) ] - {E}_{{x}_{D , Fake}} [ D ( {x}_{D , Fake} ) ] \qquad [ Equation 2 ]$$

(x_{D,Real} denotes an actual data set including input data and a measurement value, and x_{D,Fake} means a virtual data sample including the input data and an estimation value.)

In the artificial neural network model 20, the generator 21 is trained to deceive the discriminator 22 which classifies spatiotemporal characteristics of x_{D,Real} and x_{D,Fake}. Accordingly, the generator 21 may generate an estimation value following the electro mechanical brake system in the normal state.

In this regard, a loss function for training the GAN may be defined as in Equation 3 below.

$${L}_{G} = \frac{1}{N} \sum \vert {y}_{G} - {\hat{y}}_{G} \vert + \frac{k}{N} \sum [ - D ( {x}_{D , Fake} ) ] \qquad [ Equation 3 ]$$

$${L}_{D} = \frac{1}{N} \sum [ D ( {x}_{D , Fake} ) - D ( {x}_{D , Real} ) ] + \frac{1}{N} \sum [ {( {‖ {∇}_{{x}_{D , Fake}} D ( {x}_{D , Fake} ) ‖}_{2} - 1 )}^{2} ]$$

(N is an arrangement size, L_{G} is a loss function of the generator, and L_{D} is a loss function of the discriminator.)

A first loss item of the generator 21 corresponds to an average absolute error loss L_{MAE} of guidance training. The remaining loss item of the generator 21 constitutes a GAN loss function L_{GAN} with a loss of the discriminator 22.

In addition, the processor 120 detects whether the brake motor is abnormal by using a difference between an estimation value of the output variable and a measurement value of the output variable. As described above, a brake clamping force generated by the friction member displaced according to operation of the brake motor may be the output variable. In other words, the processor 120 may compare an estimation value with a measurement value of the brake clamping force to detect whether the brake motor is abnormal.

The processor 120 may execute the one or more instructions to input error data related to the difference between the estimation value of the output variable and the measurement value of the output variable to an abnormality detection model 30 to determine whether the brake motor is abnormal. For example, the abnormality detection model 30 may use a one-class support vector machine (OCSVM) algorithm.

A plurality of data sets each including the input data, a measurement value of the output variable, and an estimation value of the output variable may be present. The error data may include an average and a standard deviation of errors between the measurement values of the output variables and the estimation values of the output variables obtained from the plurality of data sets, a maximum absolute error between the measurement values of the output variables and the estimation values of the output variables obtained from the plurality of data sets, and discrimination values of the discriminator for the input data and the measurement values of the output variables included in the plurality of data sets.

A plurality of data sets each including the input data, an estimation value of the output variable, and a measurement value of the output variable may be processed as one batch. For example, 100 to 150 data sets (specifically, 128 data sets) may be processed as one batch, and the error data may be obtained for each batch.

The error data obtained for one batch may be input to the abnormality detection model 30. In addition, a level of abnormality of the brake motor (performance degradation of the brake motor) may be detected on the basis of an output (feature) obtained from the abnormality detection model 30 which receives the error data.

An F1 score given as in Equation 4 may be considered in relation to an anomaly detection metric.

$$F 1 = \frac{2 \times TP}{2 \times TP + FP + FN} \qquad [ Equation 4 ]$$

(TP denotes a true positive, FP denotes a false positive, FN denotes a false negative, and positive denotes performance degradation of the brake motor.)

Meanwhile, as described above, the discriminator 22 may calculate not only a discrimination value for input data and a measurement value of the output variable included in the data set but also a discrimination value for the input data and an estimation value of the output variable included in the data set. The discrimination value of the discriminator 22 related to the estimation value of the data set may be fed back to the generator 21 of the artificial neural network model 20 and used for training.

The configuration of the brake motor abnormality detection device 100 according to one embodiment of the present disclosure has been described in detail. Hereinafter, operation of the brake motor abnormality detection device 100 will be described in detail.

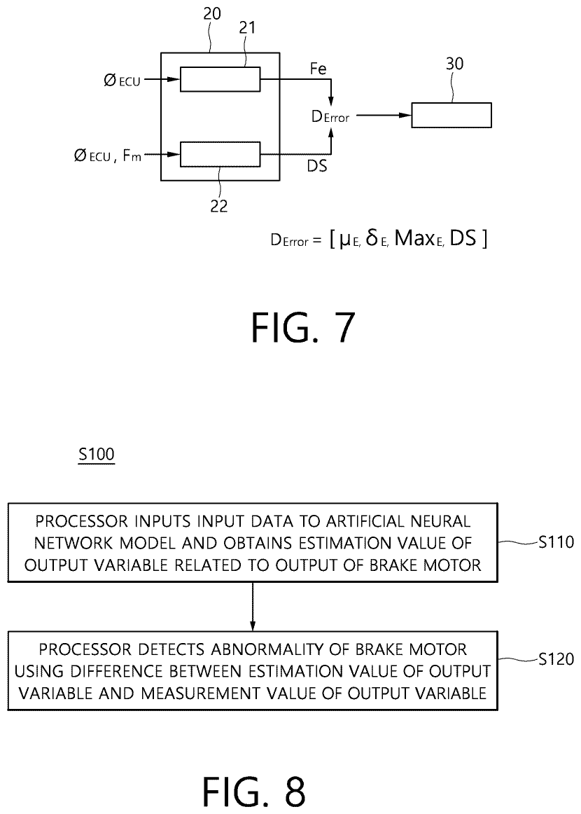

FIG. 7 is a view illustrating operation of the brake motor abnormality detection device according to one embodiment of the present disclosure.

Referring to FIG. 7, the brake motor abnormality detection device 100 according to one embodiment of the present disclosure may operate as described below.

First, the memory 110 stores input data Ø_{ECU} and a measurement value Fm of an output variable. In this case, a brake clamping force generated by the friction member of the electro mechanical brake system may be the output variable. That is, the measurement value of the output variable may include a measurement value of the brake clamping force.

As described above, the input data Ø_{ECU} may include one or more of a speed of the vehicle, a lateral acceleration of the vehicle, an input displacement of the brake pedal, and a wheel speed of the vehicle. In addition, a plurality of pieces input data Ø_{ECU} and measurement data including the measurement value Fm may be processed as one batch. That is, in one embodiment of the present disclosure, data processing and operation may be performed in units of batches.

Next, the processor 120 executes one or more instructions to input the input data Ø_{ECU} to the artificial neural network model 20 and obtain an estimation value Fe of the output variable output by the artificial neural network model 20. More specifically, the processor 120 may input the input data Ø_{ECU} to the generator 21 of the artificial neural network model 20 and obtain an estimation value of the brake clamping force output by the generator 21.

In addition, the processor 120 executes one or more instructions to input the input data Ø_{ECU} and the measurement value Fm of the output variable to the artificial neural network model 20 and obtain a discrimination value DS. More specifically, the processor 120 may input the input data Ø_{ECU} and a measurement value of the brake clamping force to the discriminator 22 and obtain the discrimination value DS.

Next, the processor 120 outputs an error data D_{Error}. The error data D_{Error} may be output for each data batch.

More specifically, a plurality of data sets each including the input data, the estimation value Fe of the output variable, and the measurement value Fm of the output variable may be present.

In this case, the error data D_{Error} may include an average μ_{E} and a standard deviation σ_{E} of errors between estimation values Fe and measurement values Fm obtained from the plurality of data sets, a maximum absolute error Max_{E} between the estimation values Fe and the measurement values Fm obtained from the plurality of data sets, and discrimination values DS of the discriminator 22 for the input data Ø_{ECU} and the measurement values Fm.

Finally, the processor 120 executes one or more instructions to input the error data D_{Error} to the abnormality detection model 30 and obtain an output of the abnormality detection model 30. As described above, the abnormality detection model 30 may include the OCSVM algorithm.

The processor 120 may detect a level of abnormality of the brake motor (performance degradation of the brake motor) on the basis of the output (feature) obtained from the abnormality detection model 30 which receives the error data D_{Error}.

As described above, the brake motor abnormality detection device 100 according to one embodiment of the present disclosure has been described in detail. Hereinafter, a brake motor abnormality detection method will be described.

FIG. 8 is a flowchart illustrating the brake motor abnormality detection method according to one embodiment of the present disclosure.

In a brake motor abnormality detection method S100 according to one embodiment of the present disclosure, abnormality of the brake motor generating a driving force to displace the friction member disposed at the side of the wheel of the vehicle to generate a braking force caused by friction due to the displacement of the friction member is detected.

Referring to FIG. 8, the brake motor abnormality detection method S100 according to one embodiment of the present disclosure may be performed as follows.

First, the processor 120 executes one or more instructions to input input data to the artificial neural network model, which receives the input data and outputs an estimation value of an output variable related to an output of the brake motor, and obtain the estimation value of the output variable (S110).

The input data may include one or more of a speed of the vehicle, a lateral acceleration of the vehicle, an input displacement of the brake pedal, and a wheel speed of the vehicle. In one embodiment of the present disclosure, the input data may include the speed of the vehicle, the lateral acceleration of the vehicle, the input displacement of the brake pedal, and the wheel speed of the vehicle.

Meanwhile, the input data may be obtained through the CAN 300 of the vehicle.

A brake clamping force generated due to the displacement of the friction member according to driving of the brake motor may be the output variable. In other words, the estimation value of the output variable may be an estimation value of the brake clamping force. In this case, the estimation value of the brake clamping force may be obtained for each wheel of the vehicle.

The estimation value of the output variable is obtained to be compared with a measurement value of the output variable. In this case, the measurement value of the output variable may be a measurement value of the brake clamping force generated due to the displacement of the friction member according to driving of the brake motor. The measurement value of the brake clamping force may be obtained for each wheel of the vehicle.

In one embodiment of the present disclosure, the artificial neural network model 20 may include the GAN. In other words, the artificial neural network model 20 may be the neural network model based on deep learning for the electro mechanical brake system of the vehicle.

The artificial neural network model 20 may include the generator 21 and the discriminator 22. The generator 21 receives the input data and generates an estimation value of the output variable. The generator 21 may be provided as the multivariate transformer. In addition, the discriminator 22 may receive the input data and a measurement value of the output variable and output a measurement related discrimination value.

In operation S110 of obtaining an estimation value of the output variable, the processor 120 may input the input data to the generator 21 and obtain an estimation value of the output variable generated by the generator 21.

Meanwhile, the artificial neural network model 20 may be built by training the generator 21 and the discriminator 22, and input data and a measurement value used du for the learning may be obtained in a normal state of each of the vehicle and the electro mechanical brake system. Accordingly, an estimation value of the output variable may follow the measurement value of the output variable obtained in the normal state of the electro mechanical brake system.

Next, the processor 120 detects whether the brake motor is abnormal by using a difference between the estimation value of the output variable and the measurement value of the output variable (S120).

The processor 120 may execute one or more instructions to input error data related to the difference between the estimation value and the measurement value to the abnormality detection model 30 to determine whether the brake motor is abnormal. For example, the abnormality detection model 30 may use the OCSVM algorithm.

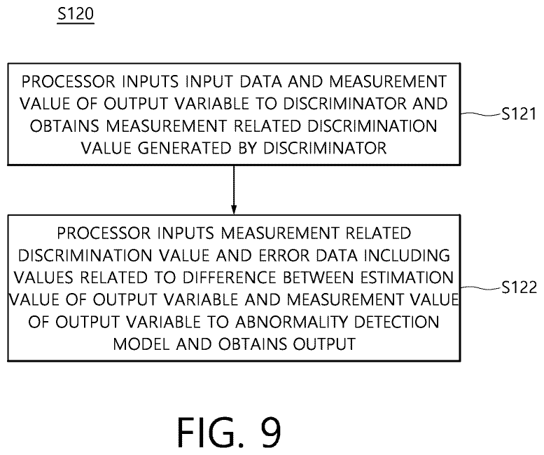

FIG. 9 is a detailed flowchart illustrating detecting whether the brake motor is abnormal in the brake motor abnormality detection method according to one embodiment of the present disclosure.

Referring to FIG. 9, operation S120 of detecting whether the brake motor is abnormal may be performed as follows.

First, the processor 120 inputs the input data and the measurement value of the output variable to the discriminator 22 and obtains a measurement related discrimination value generated by the discriminator 22 (S121).

In this case, a discrimination value output by the discriminator 22 for the input data and the measurement value of the output variable may be defined as the measurement related discrimination value.

Next, the processor 120 inputs the measurement related discrimination value and error data including values related to the difference between the estimation value of the output variable and the measurement value of the output variable to the abnormality detection model 30 and obtains an output of the abnormality detection model 30 (S122).

A plurality of data sets each including the input data, the measurement value of the output variable, and the estimation value of the output variable may be present. The error data may include an average and a standard deviation of errors between the measurement values of the output variables and the estimation values of the output variables obtained from the plurality of data sets, a maximum absolute error between the measurement values of the output variables and the estimation values of the output variables obtained from the plurality of data sets, and discrimination values of the discriminator for the input data and the measurement values of the output variables included in the plurality of data sets.

In one embodiment of the present disclosure, the error data may include an average and a standard deviation of errors between estimation values and measurement values of the brake clamping force obtained from the plurality of data sets, a maximum absolute error between the estimation values and the measurement values of the brake clamping force obtained from the plurality of data set, and discrimination values of the discriminator 22 for the input data and the measurement values of the brake clamping force included in the plurality of data sets.

A plurality of data sets each including the input data, an estimation value of the output variable, and a measurement value of the output variable may be processed as one batch. For example, 100 to 150 data sets (specifically, 128 data sets) may be processed as one batch, and the error data may be obtained for each batch.

The error data obtained for one batch may be input to the abnormality detection model 30. In addition, a level of the abnormality of the brake motor (performance degradation of the brake motor) may be detected on the basis of the output (feature) obtained from the abnormality detection model 30 which receives the error data.

Meanwhile, the present disclosure further provides the non-transitory computer-readable storage medium in which a program for performing the brake motor abnormality detection method is stored. Specifically, the present disclosure may provide the non-transitory computer-readable storage medium in which the program including at least one instruction for performing the brake motor abnormality detection method is stored.

In this case, the instruction may include a machine language code generated by a compiler. In addition, the instruction may also include a high-level language code which may be executed by a computer.

The storage medium may include a hardware device, such as magnetic media including a hard disk, a floppy disk, and a magnetic tape, optical media including a CD-ROM and a DVD, a magneto-optical media including a floptical disk, a ROM, a RAM, and a flash memory, configured to store and execute a program instruction.

The above described F1 score may be considered in relation to an anomaly detection metric showing an effect of the present disclosure.

As a result of simulation, in the case of the present disclosure, it is seen that performance of the brake motor can be predicted to be degraded to 10% of a maximum output power thereof with a F1 score of 0.85 or more. In other words, in the case of the present disclosure, a degradation level of the brake motor generating a driving force to displace the friction member disposed at the side of the wheel of the brake to generate a braking force caused by friction due to the displacement of the friction member can be accurately predicted before the brake motor completely fails.

According to the present disclosure, output degradation of the brake motor can be sensitively detected. As a result, a proactive measure can be performed before the brake motor fails, and a failure of the brake motor can be effectively prevented.

As described above, the present disclosure provides estimation of future operation and remaining effective lifetime of a system and prognostic proper to a predictive maintenance application. Accordingly, a proactive measure and maintenance can be guided before the brake motor fails.

According to the above described configuration, the brake motor abnormality detection device and method and the non-transitory computer-readable storage medium in which a program for performing the method according to one aspect of the present disclosure is stored can prognose performance degradation of the brake motor generating a driving force to displace the friction member disposed at the side of the wheel of the vehicle to generate a braking force caused by friction due to the displacement of the friction member before the brake motor fails.

In addition, the brake motor abnormality detection device and method and the non-transitory computer-readable storage medium in which a program for performing the method is stored can detect performance degradation of the brake motor using CAN signals of the vehicle without an additional sensor.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A device comprising:
a memory configured to one or more instructions; and
a processor configured to execute the one or more instructions comprising:
inputting input data, associated with one or more operations of a vehicle, to an artificial neural network model configured to, in response to the input data, output an estimation value of an output variable related to an output of a brake motor configured to generate a driving force for moving a friction member of a wheel of the vehicle to generate a braking force;
obtaining the estimation value of the output variable from the artificial neural network model; and
detecting whether the brake motor is in an abnormal state based on a difference between the estimation value of the output variable and a measurement value of the output variable.

2. The device of claim 1, wherein the input data, associated with the one or more operations of the vehicle, includes one or more of a speed of the vehicle, a lateral acceleration of the vehicle, an input displacement of a brake pedal, or a wheel speed of the vehicle.

3. The device of claim 1, wherein the output variable includes a brake clamping force generated by the friction member.

4. The device of claim 1, wherein the processor is configured to obtain the input data, associated with the one or more operations of the vehicle, through a controller area network (CAN) of the vehicle.

5. The device of claim 1, wherein the artificial neural network model is comprised in a generative adversarial network (GAN) including a generator configured to receive the input data, associated with the one or more operations of the vehicle, and generate the estimation value of the output variable and a discriminator configured to, in response to the input data, associated with the one or more operations of the vehicle, and the measurement value of the output variable, output a measurement related discrimination value.

6. The device of claim 5, wherein the discriminator is further configured to, in response to the input data, associated with the one or more operations of the vehicle, and the estimation value of the output variable, output an estimation related discrimination value.

7. The device of claim 6, wherein:
the artificial neural network model is configured to alternately perform learning of the generator and the discriminator; and
the input data and the measurement value of the output variable used for the learning of the generator and the discriminator are obtained when the vehicle and the brake motor are in a normal state.

8. The device of claim 5, wherein the generator comprises a multivariate transformer.

9. The device of claim 5, wherein the processor is configured to input error data related to the difference between the estimation value of the output variable and the measurement value of the output variable to an abnormality detection model and determine whether the brake motor is in the abnormal state based on an output of the abnormality detection model.

10. The device of claim 9, wherein the abnormality detection model is configured to use a one-class support vector machine (OCSVM) algorithm.

11. The device of claim 9, wherein:
each of a plurality of data sets includes the input data, the measurement value of the output variable, and the estimation value of the output variable; and
the error data includes an average and a standard deviation of errors between measurement values of output variables of the plurality of data sets and estimation values of output variables of the plurality of data sets, a maximum absolute error between the measurement values of the output variables of the plurality of data sets and the estimation values of the output variables of the plurality of data sets, and discrimination values of the discriminator for the input data and the measurement values of the output variables of the plurality of data sets.

12. A method comprising:
inputting input data, associated with one or more operations of a vehicle, to an artificial neural network model configured to, in response to the input data, output an estimation value of an output variable related to an output of a brake motor configured to generate a driving force for moving a friction member of a wheel of the vehicle to generate a braking force, and obtaining the estimation value of the output variable from the artificial neural network model; and
detecting whether the brake motor is in an abnormal state based on a difference between the estimation value of the output variable and a measurement value of the output variable.

13. The method of claim 12, wherein the input data, associated with the one or more operations of the vehicle, includes one or more of a speed of the vehicle, a lateral acceleration of the vehicle, an input displacement of a brake pedal, or a wheel speed of the vehicle.

14. The method of claim 12, wherein the output variable includes a brake clamping force generated by the friction member.

15. The method of claim 12, wherein the artificial neural network model is comprised in a generative adversarial network (GAN) including a generator configured to receive the input data, associated with the one or more operations of the vehicle, and generate the estimation value of the output variable and a discriminator configured to, in response to the input data, associated with the one or more operations of the vehicle, and the measurement value of the output variable, output a measurement related discrimination value.

16. The method of claim 15, wherein:
the artificial neural network model is configured to alternately perform learning of the generator and the discriminator; and
the method further comprises obtaining the input data and the measurement value of the output variable used for performing the learning of the generator and the discriminator when the vehicle and the brake motor are in a normal state.

17. The method of claim 15, wherein the detecting of whether the brake motor is in the abnormal state includes:
inputting the input data and the measurement value of the output variable to the discriminator and obtaining the measurement related discrimination value generated by the discriminator; and
inputting the measurement related discrimination value and error data including values related to the difference between the estimation value of the output variable and the measurement value of the output variable to an abnormality detection model and obtaining an output of the abnormality detection model.

18. The method of claim 17, wherein the abnormality detection model uses a one-class support vector machine (OCSVM) algorithm.

19. The method of claim 17, wherein:
each of a plurality of data sets includes the input data, the measurement value of the output variable, and the estimation value of the output variable; and
the error data includes an average and a standard deviation of errors between measurement values of output variables of the plurality of data sets and estimation values of output variables of the plurality of data sets, a maximum absolute error between the measurement values of the output variables of the generator and the discriminator and the estimation values of the output variables of the plurality of data sets, and discrimination values of the discriminator for the input data and the measurement values of the output variables of the plurality of data sets.

20. A non-transitory computer-readable storage medium configured to store instructions that when executed by one or more processors, cause the one or more processors to perform operations comprising:
inputting input data, associated with one or more operations of a vehicle, to an artificial neural network model configured to, in response to the input data, output an estimation value of an output variable related to an output of a brake motor configured to generate a driving force for moving a friction member of a wheel of the vehicle to generate a braking force, and obtaining the estimation value of the output variable from the artificial neural network model; and
detecting whether the brake motor is in an abnormal state based on a difference between the estimation value of the output variable and a measurement value of the output variable.
